(19) United States
(12) Patent Application Publication
(10) Pub. No.: US 2025/0364722 A1
(43) Pub. Date: Nov. 27, 2025

(54) ANTENNA COMPONENT

(71) Applicant: Murata Manufacturing Co., Ltd., Nagaokakyo-shi (JP)

(72) Inventors: Yusuke EDAGAWA, Nagaokakyo-shi (JP); Kosuke NISHIO, Nagaokakyo-shi (JP)

(21) Appl. No.: 19/294,733

(22) Filed: Aug. 8, 2025

Related U.S. Application Data
(63) Continuation of application No. PCT/JP2024/001284, filed on Jan. 18, 2024.

(30) Foreign Application Priority Data
Feb. 16, 2023 (JP) 2023-022151

(51) Int. Cl. H01Q 9/04

(52) U.S. Cl. CPC H01Q 9/0414

(57) ABSTRACT

An antenna component includes a radiator located on a negative side of a Z-axis relative to a first radiating conductor layer and connected to the first radiating conductor layer. A first ground conductor layer overlaps with the first radiating conductor layer and the radiator as viewed in a negative direction of the Z-axis and is located on the negative side of the Z-axis relative to the first radiating conductor layer. A composite dielectric constant of a first region is higher than a composite dielectric constant of a second region.

### CROSS REFERENCE TO RELATED APPLICATIONS

This application claims the benefit of priority to Japanese Patent Application No. 2023-022151 filed on Feb. 16, 2023 and is a Continuation application of PCT Application No. PCT/JP2024/001284 filed on Jan. 18, 2024. The entire contents of each application are hereby incorporated herein by reference.

### BACKGROUND OF THE INVENTION

### 1. Field of the Invention

The present invention relates to antenna components.

### 2. Description of the Related Art

As an invention relating to an existing antenna component, for example, an antenna component described in International Publication No. WO/2022/038925 is known. The antenna component includes a plurality of dielectric layers, a first electrode, and a first ground electrode. The plurality of dielectric layers are laminated. The first electrode and the first ground electrode are laminated together with the plurality of dielectric layers. The first electrode and the first ground electrode are opposite to each other, with the dielectric layers interposed therebetween, to form a patch antenna. Further, a filler is disposed in the dielectric layers located between the first electrode and a second electrode. The dielectric constant of the filler is lower than that of the dielectric layers. This achieves a reduction in the effective dielectric constant in the dielectric.

In the field of the antenna component described in International Publication No. WO/2022/038925, there is a demand to achieve both size reduction of the antenna component and band widening of the antenna.

### SUMMARY OF THE INVENTION

Example embodiments of the present invention each enable both a size reduction of an antenna component and band widening of an antenna.

An antenna component according to an example embodiment of the present invention includes a main body, a first radiating conductor layer, a radiator, and a first ground conductor layer. The main body includes a plurality of insulator layers arranged along a Z-axis. The first radiating conductor layer is provided in the main body. The radiator is provided in the main body and is located on a negative side of the Z-axis relative to the first radiating conductor layer, and the radiator is connected to the first radiating conductor layer and is not connected to a ground potential. The first ground conductor layer is provided in the main body and overlaps with the first radiating conductor layer and the radiator as viewed in a negative direction of the Z-axis, and the first ground conductor layer is located on the negative side of the Z-axis relative to the first radiating conductor layer. An end of the radiator on the negative side of the Z-axis is defined as a negative-side end. A region overlapping with the first radiating conductor layer as viewed in the negative direction of the Z-axis and located on a positive side of the Z-axis relative to the negative-side end and on the negative side of the Z-axis relative to the first radiating conductor layer is defined as a first region, and a region overlapping with the first radiating conductor layer as viewed in the negative direction of the Z-axis and located on the positive side of the Z-axis relative to the first ground conductor layer and on the negative side of the Z-axis relative to the negative-side end is defined as a second region. A composite dielectric constant of the first region is higher than a composite dielectric constant of the second region.

With antenna components according to example embodiments of the present invention, it is possible to achieve both a size reduction of the antenna component and band widening of the antenna.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an exploded perspective view of an antenna component 10 according to an example embodiment of the present invention.

FIG. 2 is a sectional view of the antenna component 10 along line A-A.

FIG. 3 is a back view of the antenna component 10 during use thereof.

FIG. 4 is a sectional view of an antenna component 10a according to an example embodiment of the present invention.

FIG. 5 is a top view of an antenna component 10b according to an example embodiment of the present invention.

FIG. 6 is a sectional view of an antenna component 10c according to an example embodiment of the present invention.

FIG. 7 is a sectional view of an antenna component 10d according to an example embodiment of the present invention.

FIG. 8 is a sectional view of an antenna component 10e according to an example embodiment of the present invention.

FIG. 9 is a sectional view of an antenna component 10f according to an example embodiment of the present invention.

FIG. 10 is a sectional view of an antenna component 10g according to an example embodiment of the present invention.

FIG. 11 is a top view of an antenna component 10h according to an example embodiment of the present invention.

FIG. 12 is a sectional view of an antenna substrate with built-in diplexer 30A according to an example embodiment of the present invention.

FIG. 13 is a sectional view of an antenna substrate with built-in diplexer 30B according to an example embodiment of the present invention.

FIG. 14 is a sectional view of an antenna component 10i according to an example embodiment of the present invention.

FIG. 15 is a sectional view of an antenna component 10j according to an example embodiment of the present invention.

### DETAILED DESCRIPTION OF THE EXAMPLE EMBODIMENTS

Example embodiments of the present invention will be described in detail below with reference to the drawings.

### EXAMPLE EMBODIMENTS

### Structure of Antenna Component 10

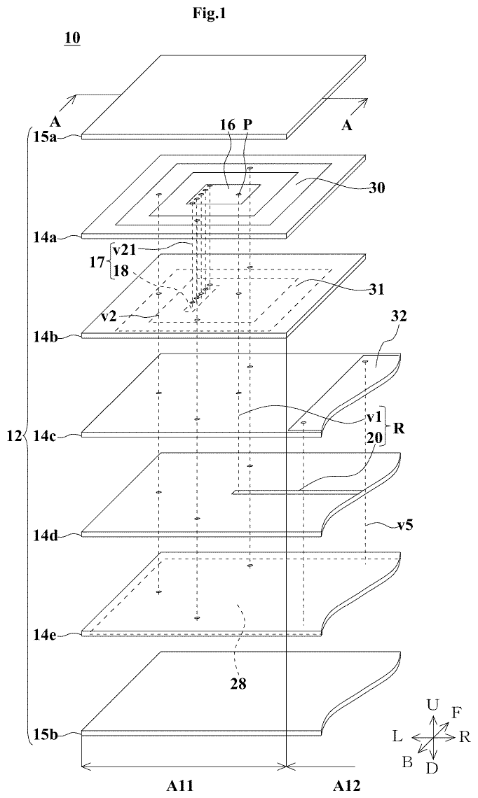

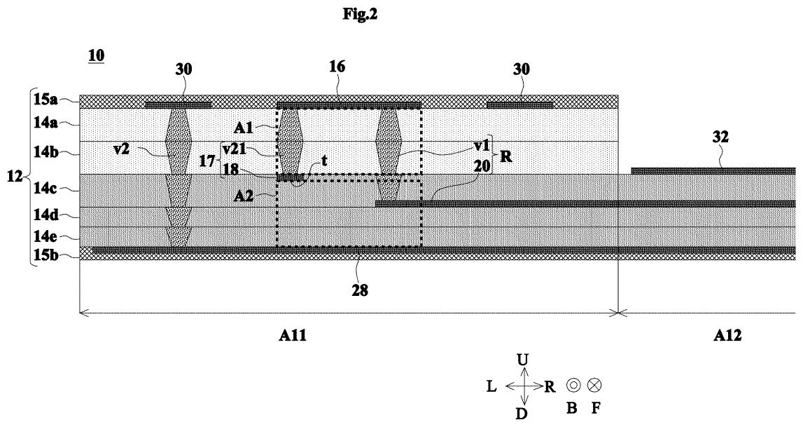

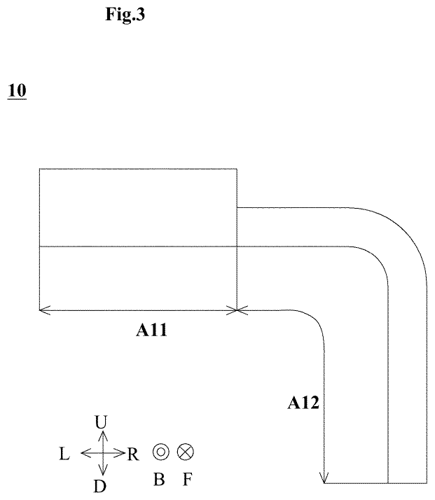

A structure of an antenna component 10 according to an example embodiment of the present invention is described below with reference to drawings. FIG. 1 is an exploded perspective view of the antenna component 10. FIG. 2 is a sectional view of the antenna component 10 along line A-A. FIG. 3 is a back view of the antenna component 10 during use thereof.

Hereinafter, the layer lamination direction of a main body 12 is parallel or substantially parallel to a vertical axis. The vertical axis corresponds with a Z-axis. An upward direction is a positive direction of the Z-axis. A downward direction is a negative direction of the Z-axis. Two sides of the main body 12 extend along a left-right axis when the main body 12 is viewed in the downward direction. The remaining two sides of the main body 12 extend along a front-back axis when the main body 12 is viewed in the downward direction. The left-right axis is orthogonal or substantially orthogonal to the vertical axis. The front-back axis is orthogonal or substantially orthogonal to the vertical axis and the left-right axis. The definition of the directions in the present specification is an example. Therefore, directions during actual use of the antenna component 10 are not required to correspond with the directions in the present specification.

The antenna component 10 is used for, for example, a wireless communication terminal such as a smartphone. As shown in FIG. 1, the antenna component 10 includes the main body 12, a first radiating conductor layer 16, a radiator 17, a first ground conductor layer 28, a second ground conductor layer 30, a fourth ground conductor layer 31, a third ground conductor layer 32, a current path R, a plurality of interlayer connection conductors v2, and a plurality of interlayer connection conductors v5.

The main body 12 has a plate shape. As shown in FIG. 1, the main body 12 has a rectangular or substantially rectangular shape as viewed in the downward direction. The main body 12 has a structure in which first insulator layers 14a and 14b, second insulator layers 14c to 14e, and insulator layers 15a and 15b (plurality of insulator layers) are laminated along the vertical axis (Z-axis). The insulator layer 15a, the first insulator layers 14a and 14b, the second insulator layers 14c to 14e, and the insulator layer 15b are arranged in this order from the upper side toward the lower side. The first insulator layers 14a and 14b have a rectangular or substantially rectangular shape as viewed in the downward direction. The second insulator layers 14c to 14e have a strip shape extending in a left-right direction as viewed in the downward direction. The first insulator layers 14a and 14b overlap with left end portions of the second insulator layers 14c to 14e as viewed in the downward direction.

The dielectric constant of the first insulator layers 14a and 14b is higher than that of the second insulator layers 14c to 14e. The first insulator layers 14a and 14b are, for example, a thermoplastic resin such as polyimide. The second insulator layers 14c to 14e are, for example, a thermoplastic resin such as a liquid crystal polymer. Among the first insulator layers 14a and 14b and the second insulator layers 14c to 14e, layers adjacent to each other are fusion-bonded. The main body 12 has flexibility. The insulator layers 15a and 15b are described later.

The first radiating conductor layer 16 and the radiator 17 radiate and/or receive a high frequency signal. The first radiating conductor layer 16 is disposed in the main body 12. In the present example embodiment, the first radiating conductor layer 16 is located on the upper major surface of the first insulator layer 14a. As shown in FIG. 1, the first radiating conductor layer 16 has a rectangular or substantially rectangular shape as viewed in the downward direction. As shown in FIG. 1, the first radiating conductor layer 16 includes two sides extending along the front-back axis and two sides extending along the left-right axis as viewed in the downward direction. In the first radiating conductor layer 16, the left side and the right side are longer than the front side and the back side.

The radiator 17 is disposed in the main body 12. The radiator 17 is located on the lower side (negative side of the Z-axis) relative to the first radiating conductor layer 16. Specifically, the radiator 17 includes an interlayer connection conductor v21 and a second radiating conductor layer 18.

The second radiating conductor layer 18 is disposed in the main body 12. In the present example embodiment, the second radiating conductor layer 18 is located on the lower major surface of the first insulator layer 14b. Thus, the second radiating conductor layer 18 is located on the lower side (negative side of the Z-axis) relative to the first radiating conductor layer 16. As shown in FIG. 1, the second radiating conductor layer 18 has a rectangular or substantially rectangular shape as viewed in the downward direction. As shown in FIG. 1, the second radiating conductor layer 18 includes two sides extending along the front-back axis and two sides extending along the left-right axis as viewed in the downward direction. In the second radiating conductor layer 18, the left side and the right side are longer than the front side and the back side. Further, the left side of the second radiating conductor layer 18 overlaps with the left side of the first radiating conductor layer 16 as viewed in the downward direction. As a result, at least a portion of the second radiating conductor layer 18 overlaps with the first radiating conductor layer 16 as viewed in the downward direction (negative direction of the Z-axis). In the present example embodiment, the entirety or substantially the entirety of the second radiating conductor layer 18 overlaps with the first radiating conductor layer 16 as viewed in the downward direction (negative direction of the Z-axis).

However, the area of the second radiating conductor layer 18 is smaller than that of the first radiating conductor layer 16 as viewed in the downward direction (negative direction of the Z-axis). Thus, the second radiating conductor layer 18 overlaps with only the vicinity of the left side of the first radiating conductor layer 16 as viewed in the downward direction. Moreover, the length of the second radiating conductor layer 18 in the front-back direction is equal or substantially equal to that of the first radiating conductor layer 16 in the front-back direction.

Further, in the present example embodiment, the second radiating conductor layer 18 does not protrude from the first radiating conductor layer 16 as viewed in the downward direction.

The interlayer connection conductor v21 is disposed in the main body 12. The interlayer connection conductor v21 penetrates the first insulator layers 14a and 14b (one or more among the plurality of insulator layers) along the vertical axis (Z-axis). The interlayer connection conductor v21 connects the first radiating conductor layer 16 to the second radiating conductor layer 18. Thus, the upper end (end on the positive side of the Z-axis) of the interlayer connection conductor v21 is in contact with the first radiating conductor layer 16. The lower end (end on the negative side of the Z-axis) of the interlayer connection conductor v21 is in contact with the second radiating conductor layer 18. This connects the radiator 17 to the first radiating conductor layer 16. However, the radiator 17 is not connected to a ground potential.

As shown in FIG. 1, the first ground conductor layer 28 is disposed in the main body 12. Specifically, the first ground conductor layer 28 is located on the lower side (negative side of the Z-axis) relative to the first radiating conductor layer 16. The first ground conductor layer 28 is located on the lower major surface of the second insulator layer 14e. As shown in FIG. 1, the first ground conductor layer 28 has a rectangular or substantially rectangular shape as viewed in the downward direction. The first ground conductor layer 28 covers the entirety or substantially the entirety of the lower major surface of the second insulator layer 14e. Thus, the first ground conductor layer 28 overlaps with the first radiating conductor layer 16 as viewed in the downward direction (negative direction of the Z-axis). The first ground conductor layer 28 is connected to the ground potential. Due to this, the first radiating conductor layer 16, the radiator 17, and the first ground conductor layer 28 define a patch antenna.

Resonance of an electromagnetic field occurs in the first radiating conductor layer 16 and the radiator 17 described above. A direction in which an electric field resonates in the first radiating conductor layer 16 is defined as a resonance direction. The resonance direction is the left-right direction. A direction orthogonal or substantially orthogonal to the resonance direction as viewed in the downward direction (negative direction of the Z-axis) is defined as an orthogonal direction. The orthogonal direction is the front-back direction. The length of the first radiating conductor layer 16 in the orthogonal direction is longer than that of the first radiating conductor layer 16 in the resonance direction. Therefore, in the first radiating conductor layer 16, the left side and the right side are longer than the front side and the back side. Moreover, the length of the second radiating conductor layer 18 in the orthogonal direction is equal or substantially equal to that of the first radiating conductor layer 16 in the orthogonal direction.

As shown in FIG. 1, the second ground conductor layer 30 is disposed in the main body 12. Specifically, the second ground conductor layer 30 is located on the upper major surface of the first insulator layer 14a. Thus, the second ground conductor layer 30 is located on the upper side (positive side of the Z-axis) relative to the first ground conductor layer 28.

Further, the second ground conductor layer 30 has a ring shape surrounding the first radiating conductor layer 16 as viewed in the downward direction (negative direction of the Z-axis). The outer edge and the inner edge of the second ground conductor layer 30 have a rectangular or substantially rectangular shape having two sides extending along the front-back axis and two sides extending along the left-right axis. Thus, the second ground conductor layer 30 does not overlap with the first radiating conductor layer 16 as viewed in the downward direction (negative direction of the Z-axis). The second ground conductor layer 30 is connected to the ground potential.

As shown in FIG. 1, the fourth ground conductor layer 31 is disposed in the main body 12. Specifically, the fourth ground conductor layer 31 is located on the lower major surface of the first insulator layer 14b. Thus, the fourth ground conductor layer 31 is located on the upper side (positive side of the Z-axis) relative to the first ground conductor layer 28.

Moreover, the fourth ground conductor layer 31 has a ring shape surrounding the first radiating conductor layer 16 as viewed in the downward direction (negative direction of the Z-axis). The outer edge and the inner edge of the fourth ground conductor layer 31 have a rectangular or substantially rectangular shape including two sides extending along the front-back axis and two sides extending along the left-right axis. Thus, the fourth ground conductor layer 31 does not overlap with the first radiating conductor layer 16 as viewed in the downward direction. The fourth ground conductor layer 31 is connected to the ground potential.

The high frequency signal is transmitted in the current path R. The current path R is connected to the first radiating conductor layer 16. The current path R includes an interlayer connection conductor v1 and a signal conductor layer 20. The signal conductor layer 20 is disposed in the main body 12. In the present example embodiment, the signal conductor layer 20 is located on the upper major surface of the second insulator layer 14d. The signal conductor layer 20 has a linear shape extending in the left-right direction. A left end portion of the signal conductor layer 20 overlaps with the first radiating conductor layer 16 as viewed in the downward direction.

The interlayer connection conductor v1 is disposed in the main body 12. The interlayer connection conductor v1 penetrates the first insulator layers 14a and 14b and the second insulator layer 14c along the vertical axis. The interlayer connection conductor v1 connects the first radiating conductor layer 16 to the signal conductor layer 20. Thus, the upper end of the interlayer connection conductor v1 is in contact with the first radiating conductor layer 16. The position at which the interlayer connection conductor v1 is in contact with the first radiating conductor layer 16 is a feed point P. The lower end of the interlayer connection conductor v1 is in contact with the left end portion of the signal conductor layer 20.

As shown in FIG. 1, the third ground conductor layer 32 is disposed in the main body 12. Specifically, the third ground conductor layer 32 is located on the lower side relative to the first radiating conductor layer 16 and on the upper side relative to the signal conductor layer 20. The third ground conductor layer 32 is located on the upper major surface of the second insulator layer 14c. As shown in FIG. 1, the third ground conductor layer 32 has a rectangular or substantially rectangular shape as viewed in the downward direction. The third ground conductor layer 32 overlaps with the signal conductor layer 20 as viewed in the downward direction (negative direction of the Z-axis). However, the third ground conductor layer 32 does not overlap with the first radiating conductor layer 16 as viewed in the downward direction. The third ground conductor layer 32 is connected to the ground potential. Due to this, the signal conductor layer 20, the first ground conductor layer 28, and the third ground conductor layer 32 define a strip line structure.

The insulator layer 15a covers the upper major surface of the first insulator layer 14a, the first radiating conductor layer 16, and the second ground conductor layer 30. The insulator layer 15b covers the lower major surface of the second insulator layer 14e and the first ground conductor layer 28. The insulator layers 15a and 15b are protective layers. The insulator layers 15a and 15b are solder resists. The material of the solder resist is, for example, an epoxy resin or special acrylate.

Here, the lower end (end on the negative side of the Z-axis) of the radiator 17 is defined as a negative-side end t. In the present example embodiment, the negative-side end t is the lower major surface of the second radiating conductor layer 18. A region overlapping with the first radiating conductor layer 16 as viewed in the downward direction (negative direction of the Z-axis) and located on the upper side (positive side of the Z-axis) relative to the negative-side end t and on the lower side (negative side of the Z-axis) relative to the first radiating conductor layer 16 is defined as a first region A1. A region overlapping with the first radiating conductor layer 16 as viewed in the downward direction (negative direction of the Z-axis) and located on the upper side (positive side of the Z-axis) relative to the first ground conductor layer 28 and on the lower side (negative side of the Z-axis) relative to the negative-side end t is defined as a second region A2. At this time, the first insulator layers 14a and 14b are located in the first region A1. The second insulator layers 14c to 14e are located in the second region A2. As a result, the composite dielectric constant of the first region A1 is higher than that of the second region A2.

An example of a calculation method for the composite dielectric constant is described below. A case in which a first substance to an n-th substance exist in the first region A1 is described as an example. n is a natural number. The dielectric constant of the first substance to the n-th substance is defined as ε1 to εn. The thickness along the vertical axis of the first substance to the n-th substance in the first region A1 is defined as d1 to dn. At this time, a composite dielectric constant ε0 is represented by the following mathematical expression (1).

ε0=(d1+d2+ . . . +dn)/(d1/ε1+d2/ε2++dn/εn) (1)

The plurality of interlayer connection conductors v2 are disposed in the main body 12. The plurality of interlayer connection conductors v2 electrically connect the first ground conductor layer 28 to the second ground conductor layer 30. Specifically, the plurality of interlayer connection conductors v2 penetrate the first insulator layers 14a and 14b and the second insulator layers 14c to 14e along the vertical axis. The upper ends of the plurality of interlayer connection conductors v2 are in contact with the second ground conductor layer 30. The lower ends of the plurality of interlayer connection conductors v2 are in contact with the first ground conductor layer 28.

The plurality of interlayer connection conductors v5 are disposed in the main body 12. The plurality of interlayer connection conductors v5 electrically connect the first ground conductor layer 28 to the third ground conductor layer 32. Specifically, the plurality of interlayer connection conductors v5 penetrate the second insulator layers 14c to 14e along the vertical axis. The upper ends of the plurality of interlayer connection conductors v5 are in contact with the third ground conductor layer 32. The lower ends of the plurality of interlayer connection conductors v5 are in contact with the first ground conductor layer 28.

The first radiating conductor layer 16, the second radiating conductor layer 18, the signal conductor layer 20, the first ground conductor layer 28, the second ground conductor layer 30, the fourth ground conductor layer 31, and the third ground conductor layer 32 described above are formed by patterning for a metal foil applied to the upper major surface or the lower major surface of the first insulator layer 14a or 14b or the second insulator layer 14c to 14e. The metal foil is, for example, a copper foil. The interlayer connection conductors v1, v2, v5, and v21 are formed by filling through-holes penetrating the first insulator layer 14a or 14b or the second insulator layer 14c to 14e along the vertical axis with an electrically-conductive paste and solidifying the electrically-conductive paste by heating and pressurization. The interlayer connection conductors v1, v2, v5, and v21 may be formed by, for example, executing plating for the through-holes.

Next, an example of a method of use of the antenna component 10 is described. As shown in FIGS. 1 to 3, the antenna component 10 includes a first section A11 and a second section A12. The first section A11 overlaps with the first insulator layers 14a and 14b as viewed in the downward direction. The second section A12 does not overlap with the first insulator layers 14a and 14b as viewed in the downward direction. The vertical thickness of the antenna component 10 in the second section A12 is smaller than that of the antenna component 10 in the first section A11. Therefore, the second section A12 is deformed more easily than the first section A11. Thus, as shown in FIG. 3, the second section A12 is bent in the downward direction or the upward direction.

### Advantageous Effects

It is possible to achieve both a size reduction of the antenna component 10 and band widening of the antenna. Specifically, the radiator 17 is connected to the first radiating conductor layer 16. Thus, the first radiating conductor layer 16 and the radiator 17 define a patch antenna. Further, the half wavelength of the high frequency signal corresponds with the sum of the length of the first radiating conductor layer 16 in the left-right direction, the vertical length of the interlayer connection conductor v21, and the length from the interlayer connection conductor v21 to the right end of the second radiating conductor layer 18. Thus, the length of the first radiating conductor layer 16 in the left-right direction may be short. This reduces the size of the antenna component 10 as viewed in the downward direction.

High capacitance is likely to be generated between the radiator 17 and the first ground conductor layer 28. When high capacitance is generated between the radiator 17 and the first ground conductor layer 28, the quality factor of the resonant antenna such as a patch antenna becomes high. As a result, band narrowing of the antenna is likely to occur.

To address this problem, in the antenna component 10, the composite dielectric constant of the first region A1 is higher than that of the second region A2. That is, the composite dielectric constant of the second region A2 is lower than that of the first region A1. As a result, high capacitance is less likely to be generated between the radiator 17 and the first ground conductor layer 28. Thus, the quality factor of the antenna becomes low, and band widening of the antenna is achieved. Moreover, when the quality factor of the antenna becomes low, the radiation efficiency of the antenna improves.

In the antenna component 10, the composite dielectric constant of the first region A1 is higher than that of the second region A2. This facilitates the occurrence of a wavelength shortening effect in the first radiating conductor layer 16. As a result, the size reduction of the first radiating conductor layer 16 is achieved. Thus, the size of the antenna component 10 is reduced as viewed in the downward direction.

In the antenna component 10, as viewed in the downward direction, the area of an overlapping region that overlaps with the first radiating conductor layer 16 in the second radiating conductor layer 18 is larger than that of a non-overlapping region that does not overlap with the first radiating conductor layer 16 in the second radiating conductor layer 18. Thus, the amount of protrusion of the second radiating conductor layer 18 from the first radiating conductor layer 16 is small as viewed in the downward direction. As a result, the size of the antenna component 10 is reduced as viewed in the downward direction.

In the second radiating conductor layer 18 of the antenna component 10, the resonance direction is the left-right direction. Therefore, a current flows in the left direction or the right direction. Thus, the length of the second radiating conductor layer 18 in the orthogonal direction is equal or substantially equal to that of the first radiating conductor layer 16 in the orthogonal direction. Due to this, the length of the second radiating conductor layer 18 in the front-back direction is long, and a reduction in the resistance of the second radiating conductor layer 18 is achieved. As a result, the radiation efficiency of the antenna improves.

In the first radiating conductor layer 16 of the antenna component 10, the resonance direction is the left-right direction. Therefore, the current flows in the left direction or the right direction. Thus, the length of the first radiating conductor layer 16 in the orthogonal direction is longer than that of the first radiating conductor layer 16 in the resonance direction. Due to this, the length of the first radiating conductor layer 16 in the front-back direction is long, and a reduction in the resistance of the first radiating conductor layer 16 is achieved. As a result, the radiation efficiency of the antenna improves.

In the antenna component 10, the vertical thickness of the antenna component 10 in the second section A12 is smaller than that of the antenna component 10 in the first section A11. Therefore, the second section A12 is deformed more easily than the first section A11. Thus, the second section A12 can be bent in the downward direction or the upward direction.

In the antenna component 10, the second ground conductor layer 30 has the ring shape surrounding the first radiating conductor layer 16 as viewed in the downward direction. This reduces or prevents electromagnetic waves radiated by the first radiating conductor layer 16 from reaching a component around the antenna component 10. Further, electromagnetic waves radiated by a component around the antenna component 10 are reduced or prevented from reaching the first radiating conductor layer 16. Moreover, the directivity of the antenna improves.

### First Modification

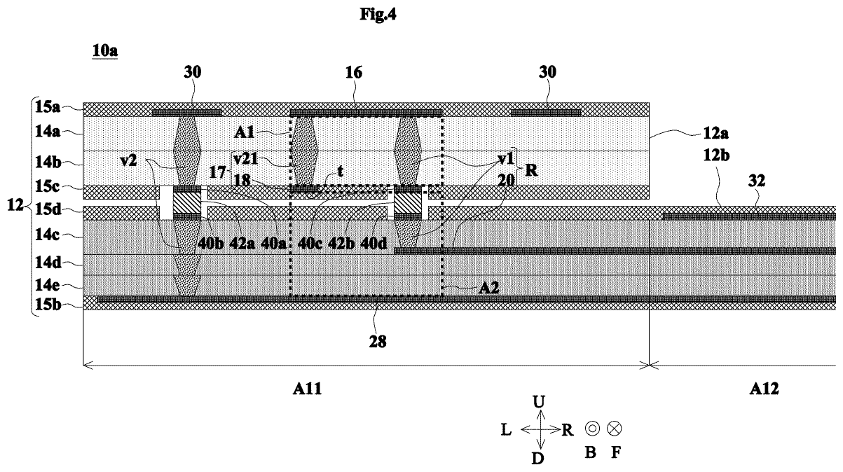

An antenna component 10a according to a first modification of an example embodiment of the present invention is described below with reference to a drawing. FIG. 4 is a sectional view of the antenna component 10a.

The antenna component 10a is different from the antenna component 10 in that the main body 12 includes a first main portion 12a and a second main portion 12b. Specifically, the first main portion 12a includes the first insulator layers 14a and 14b and the insulator layers 15a and 15c. The insulator layer 15c covers the lower major surface of the first insulator layer 14b. The second main portion 12b includes the second insulator layers 14c to 14e and the insulator layers 15b and 15d. The insulator layer 15d covers the upper major surface of the second insulator layer 14c.

Moreover, the antenna component 10a further includes mounting electrodes 40a to 40d and solders 42a and 42b. The mounting electrodes 40a and 40c are located on the lower major surface of the first insulator layer 14b. The mounting electrode 40a is in contact with the lower end of an upper portion of the interlayer connection conductor v2. The mounting electrode 40c is in contact with the lower end of an upper portion of the interlayer connection conductor v1.

The mounting electrodes 40b and 40d are located on the upper major surface of the second insulator layer 14c. The mounting electrode 40b is in contact with the upper end of a lower portion of the interlayer connection conductor v2. The mounting electrode 40d is in contact with the upper end of a lower portion of the interlayer connection conductor v1.

The solder 42a is an electrically-conductive bonding material that connects the mounting electrode 40a to the mounting electrode 40b. The solder 42b is an electrically-conductive bonding material that connects the mounting electrode 40c to the mounting electrode 40d.

Here, in the second region A2, the insulator layers 15c and 15d, air, and the second insulator layers 14c, 14d, and 14e exist. Therefore, the composite dielectric constant of the second region A2 is obtained from the dielectric constant of the insulator layers 15c and 15d, the dielectric constant of the air, the dielectric constant of the second insulator layers 14c, 14d, and 14e, the volume of the insulator layers 15c and 15d, the volume of the air, and the volume of the second insulator layers 14c, 14d, and 14e. The other structure of the antenna component 10a is the same or substantially the same as the antenna component 10, and thus description thereof is omitted. The antenna component 10a can provide the same or substantially the same advantageous effects as the antenna component 10.

### Second Modification

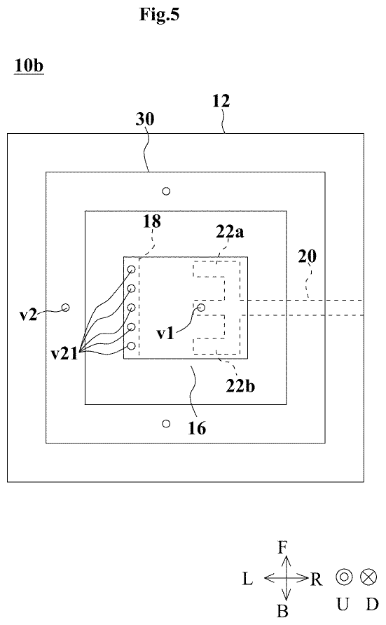

An antenna component 10b according to a second modification of an example embodiment of the present invention is described below with reference to a drawing. FIG. 5 is a top view of the antenna component 10b.

The antenna component 10b is different from the antenna component 10 in that the antenna component 10b further includes branch conductors 22a and 22b. The branch conductors 22a and 22b branch from the current path R. Specifically, the branch conductor 22a branches in the front direction from the signal conductor layer 20. The branch conductor 22b branches in the back direction from the signal conductor layer 20. Therefore, the signal conductor layer 20 and the branch conductors 22a and 22b are included in one conductor layer. The branch conductors 22a and 22b are located on the lower major surface of the second insulator layer 14c. Thus, the branch conductors 22a and 22b are located in the second region A2. Further, the branch conductors 22a and 22b overlap with the first radiating conductor layer 16 as viewed in the downward direction (negative direction of the Z-axis). The branch conductors 22a and 22b are located within a range of about ½ or less of the wavelength of the high frequency signal from the first radiating conductor layer 16. Such branch conductors 22a and 22b are open stubs. Therefore, the branch conductors 22a and 22b are not connected to a conductor layer other than the signal conductor layer 20. The other structure of the antenna component 10b is the same or substantially the same as the antenna component 10, and thus description thereof is omitted. The antenna component 10b can provide the same or substantially the same advantageous effects as the antenna component 10.

Moreover, the branch conductors 22a and 22b branch from the current path R. Thus, the branch conductors 22a and 22b enable matching between characteristic impedance in the first radiating conductor layer 16 and characteristic impedance in the current path R. As a result, reflection of the high frequency signal is reduced or prevented at the boundary between the first radiating conductor layer 16 and the current path R, and loss of the high frequency signal is reduced.

It is preferable for the branch conductors 22a and 22b not to be spaced a large distance away from the first radiating conductor layer 16 for the following reason. Refection of the high frequency signal occurs at the feed point P. The reflected high frequency signal is reflected again at the branch conductors 22a and 22b. The reflected wave is radiated from the first radiating conductor layer 16 as an electromagnetic wave. In this manner, the reflected wave is used as the electromagnetic wave of the high frequency signal in the antenna component 10b.

If the branch conductors 22a and 22b are space a large distance away from the first radiating conductor layer 16, loss occurs in the reflected wave between the branch conductors 22a and 22b and the first radiating conductor layer 16. Thus, it is preferable for the branch conductors 22a and 22b not to be spaced a large distance away from the first radiating conductor layer 16. In the antenna component 10b, the branch conductors 22a and 22b are located within the range of about ½ or less of the wavelength of the high frequency signal from the first radiating conductor layer 16. Thus, the influence of the reflected wave due to impedance matching can be made small, and the loss can be reduced.

### Third Modification

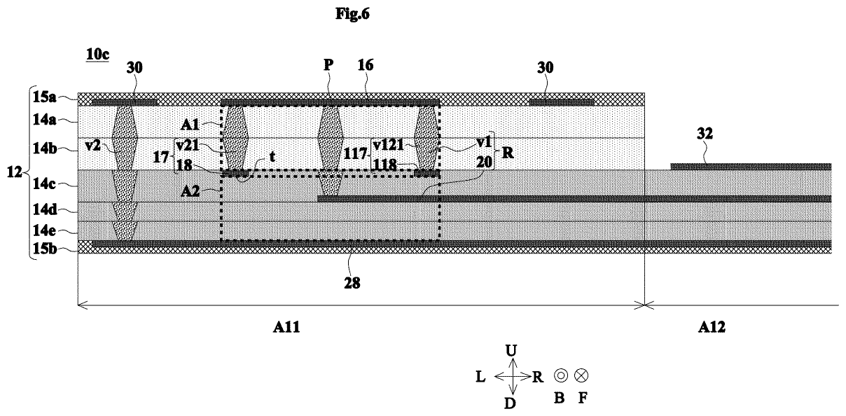

An antenna component 10c according to a third modification of an example embodiment of the present invention is described below with reference to a drawing. FIG. 6 is a sectional view of the antenna component 10c.

The antenna component 10c is different from the antenna component 10 in that the antenna component 10c further includes a radiator 117. A structure of the radiator 117 is in a symmetric relationship with the radiator 117 with respect to the feed point P in the left-right direction, and thus description thereof is omitted. The other structure of the antenna component 10c is the same or substantially the same as the antenna component 10, and thus description thereof is omitted. The antenna component 10c can provide the same or substantially the same advantageous effects as the antenna component 10.

The antenna component 10c further includes the radiator 117. Thus, the first radiating conductor layer 16 and the radiators 17 and 117 define a patch antenna. Further, the half wavelength of the high frequency signal corresponds with the sum of the length of the first radiating conductor layer 16 in the left-right direction, the vertical length of the interlayer connection conductor v21, the length from the interlayer connection conductor v21 to the right end of the second radiating conductor layer 18, the vertical length of an interlayer connection conductor v121, and the length from the interlayer connection conductor v121 to the left end of a second radiating conductor layer 118. Due to this, the size of the antenna component 10c is reduced as viewed in the downward direction. In addition, the symmetry of radiation characteristics of the antenna component 10c is improved.

### Fourth Modification

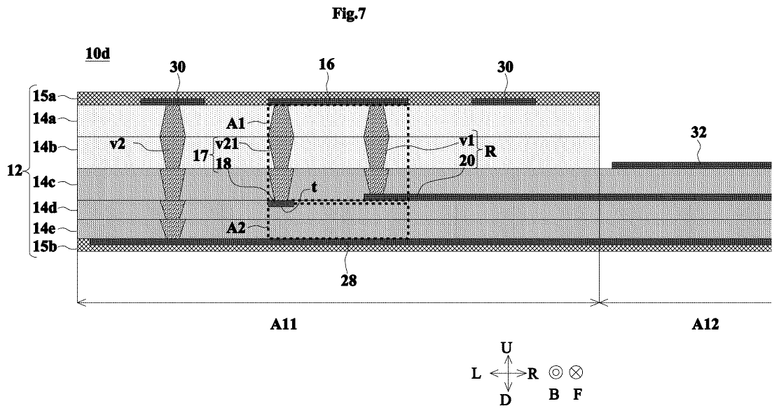

An antenna component 10d according to a fourth modification of an example embodiment of the present invention is described below with reference to a drawing. FIG. 7 is a sectional view of the antenna component 10d.

The antenna component 10d is different from the antenna component 10 in that the second radiating conductor layer 18 is located on the lower major surface of the second insulator layer 14c. The other structure of the antenna component 10d is the same or substantially the same as the antenna component 10, and thus description thereof is omitted. The antenna component 10d can provide the same or substantially the same advantageous effects as the antenna component 10.

### Fifth Modification

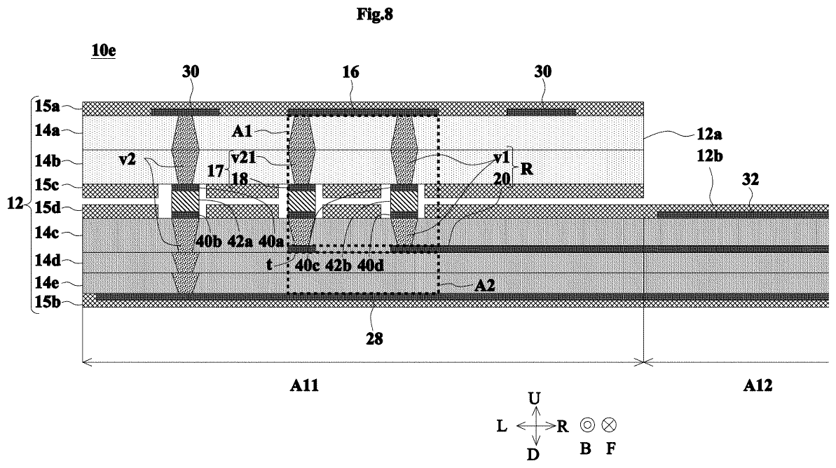

An antenna component 10e according to a fifth modification of an example embodiment of the present invention is described below with reference to a drawing. FIG. 8 is a sectional view of the antenna component 10e.

The antenna component 10e is different from the antenna component 10d in that the main body 12 includes the first main portion 12a and the second main portion 12b. Further, the second radiating conductor layer 18 is disposed in the second main portion 12b. The other structure of the antenna component 10e is the same or substantially the same as the antenna component 10d, and thus description thereof is omitted. The antenna component 10e can provide the same or substantially the same advantageous effects as the antenna component 10d.

### Sixth Modification

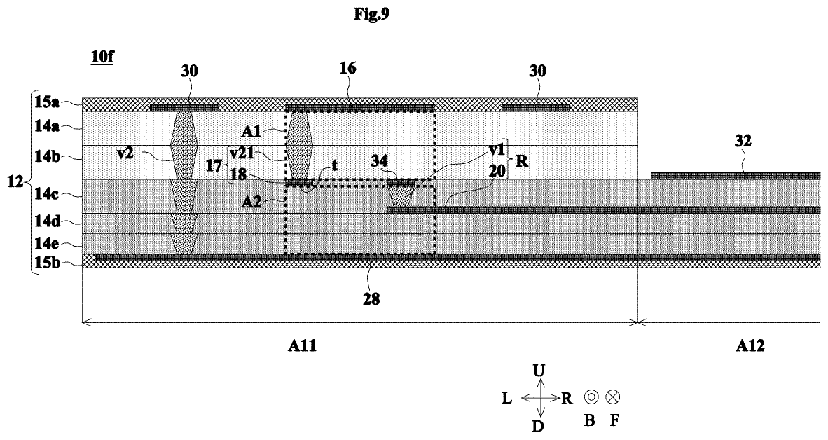

An antenna component 10f according to a sixth modification of an example embodiment of the present invention is described below with reference to a drawing. FIG. 9 is a sectional view of the antenna component 10f.

In the antenna component 10f, the upper end of the interlayer connection conductor v1 is not in contact with the first radiating conductor layer 16. The antenna component 10f further includes a feed conductor layer 34. The feed conductor layer 34 is located on the lower major surface of the first insulator layer 14b. Moreover, the feed conductor layer 34 overlaps with the first radiating conductor layer 16 as viewed in the downward direction. Thus, capacitance is generated between the first radiating conductor layer 16 and the feed conductor layer 34. The upper end of the interlayer connection conductor v1 is in contact with the feed conductor layer 34.

In the antenna component 10f described above, the high frequency signal is transmitted between the feed conductor layer 34 and the first radiating conductor layer 16 through the capacitance between the first radiating conductor layer 16 and the feed conductor layer 34. The other structure of the antenna component 10f is the same or substantially the same as the antenna component 10, and thus description thereof is omitted. The antenna component 10f can provide the same or substantially the same advantageous effects as the antenna component 10.

### Seventh Modification

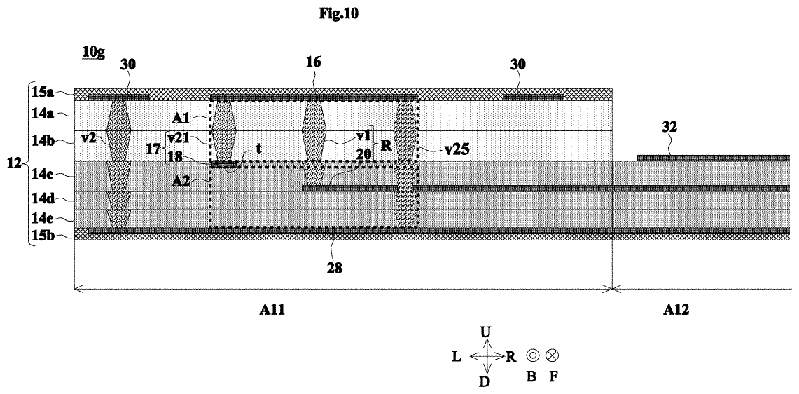

An antenna component 10g according to a seventh modification of an example embodiment of the present invention is described below with reference to a drawing. FIG. 10 is a sectional view of the antenna component 10g.

The antenna component 10g is different from the antenna component 10 in that the antenna component 10g further includes an interlayer connection conductor v25. The interlayer connection conductor v25 connects the first radiating conductor layer 16 to the first ground conductor layer 28. Thus, the first radiating conductor layer 16, the radiator 17, the first ground conductor layer 28, and the interlayer connection conductor v25 define an inverted-F antenna. Due to this, it is sufficient that the length of the antenna is about ¼ wavelength. Thus, size reduction of the antenna component 10g is achieved. The other structure of the antenna component 10g is the same or substantially the same as the antenna component 10, and thus description thereof is omitted. The antenna component 10g can provide the same or substantially the same advantageous effects as the antenna component 10.

### Eighth Modification

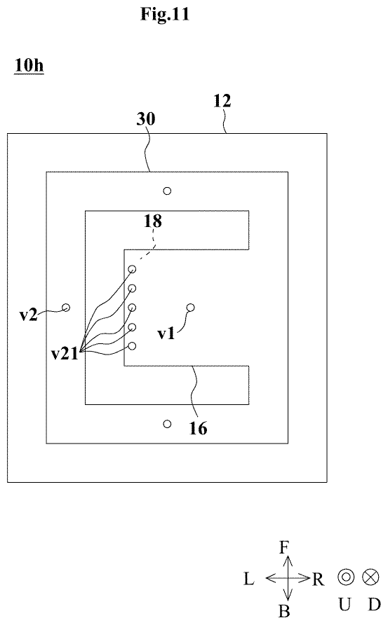

An antenna component 10h according to an eighth modification of an example embodiment of the present invention is described below with reference to a drawing. FIG. 11 is a top view of the antenna component 10h.

The antenna component 10h is different from the antenna component 10 in that the first radiating conductor layer 16 is connected to the second ground conductor layer 30. Due to this, the first radiating conductor layer 16, the radiator 17, the first ground conductor layer 28, and the second ground conductor layer 30 define an inverted-F antenna. The other structure of the antenna component 10h is the same or substantially the same as the antenna component 10, and thus description thereof is omitted. The antenna component 10h can provide the same or substantially the same advantageous effects as the antenna component 10.

### Other Example Embodiments

The antenna component according to the present invention is not limited to the antenna components 10 and 10a to 10h according to example embodiments of the present invention and modifications thereof, and can be changed within the scope of the present invention. Further, any combination from the structures of the antenna components 10 and 10a to 10h may be used.

The radiator 17 may have a structure other than the shown structure. The radiator 17 may further include an interlayer connection conductor and a second radiating conductor layer. In this case, the second radiating conductor layer is connected to the second radiating conductor layer 18 through the interlayer connection conductor. The second radiating conductor layer may be located on the lower side relative to the second radiating conductor layer 18, or may be located on the upper side relative to the second radiating conductor layer 18.

The second radiating conductor layer 18 is not an essential element. Therefore, the radiator 17 may include only the interlayer connection conductor v21.

The second ground conductor layer 30 is not an essential element.

The second radiating conductor layer 18 may protrude from the first radiating conductor layer 16. In this case, as viewed in the downward direction, the area of the overlapping region that overlaps with the first radiating conductor layer 16 in the second radiating conductor layer 18 may be larger than that of the non-overlapping region that does not overlap with the first radiating conductor layer 16 in the second radiating conductor layer 18 or may be equal to or smaller than that of the non-overlapping region that does not overlap with the first radiating conductor layer 16 in the second radiating conductor layer 18.

The length of the second radiating conductor layer 18 in the orthogonal direction is not required to be equal or substantially equal to that of the first radiating conductor layer 16 in the orthogonal direction.

The length of the first radiating conductor layer 16 in the orthogonal direction may be equal to or shorter than that of the first radiating conductor layer 16 in the resonance direction.

The branch conductors 22a and 22b are not required to overlap with the first radiating conductor layer 16 as viewed in the downward direction.

The branch conductors 22a and 22b may be, for example, a short stub.

The branch conductors 22a and 22b may be located in the first region A1.

For example, the material of the first insulator layers 14a and 14b may be a ceramic, and the material of the second insulator layers 14c to 14e may be a liquid crystal polymer or polyimide. Further, for example, the material of the first insulator layers 14a and 14b may be a liquid crystal polymer including a filler, and the material of the second insulator layers 14c to 14e may be the liquid crystal polymer. In this case, the dielectric constant of the filler is lower than that of the liquid crystal polymer. Moreover, for example, the material of the first insulator layers 14a and 14b may be polyimide including a filler, and the material of the second insulator layers 14c to 14e may be polyimide. In this case, the dielectric constant of the filler is lower than that of polyimide.

When the material of the first insulator layers 14a and 14b is a ceramic in the antenna component 10a, the first main portion 12a is an electronic component that does not have flexibility. Meanwhile, the second main portion 12b is a circuit board having flexibility. In this case, the first section A11 cannot bend, and the second section A12 can bend.

The antenna components 10 and 10a to 10h are not required to include the second section A12. In this case, an outer electrode is disposed on the lower major surface of the second insulator layer 14e. The lower end of the interlayer connection conductor v1 is in contact with the outer electrode.

In the antenna component 10f, the feed conductor layer 34 may be located on the upper side relative to the second insulator layers 14c to 14e. This reduces the number of interlayer connection conductors in the antenna component 10f.

The second radiating conductor layer 18 may protrude from the first radiating conductor layer 16 as viewed in the downward direction. However, as viewed in the downward direction (negative direction of the Z-axis), the area of the overlapping region that overlaps with the first radiating conductor layer 16 in the second radiating conductor layer 18 is larger than that of the non-overlapping region that does not overlap with the first radiating conductor layer 16 in the second radiating conductor layer 18.

Features of the example embodiments of present invention described above include multiple dielectrics with different dielectric constants. As described above, in the example embodiment of the antenna component 10 shown in FIG. 2, the composite dielectric constant of the second region A2 is lower than that of the first region A1. As a result, high capacitance is less likely to be generated between the radiator 17 and the first ground conductor layer 28. Thus, the quality factor of the antenna becomes low, and band widening of the antenna is achieved. Moreover, when the quality factor of the antenna becomes low, the radiation efficiency of the antenna improves. The same principles can be applied to an antenna substrate with a built-in diplexer.

An antenna driven by multiband by incorporating a diplexer in the antenna is known, for example, in Japanese Publication No. JPH11-502386A. The following example embodiments of the present invention will be described in which the antenna portion is provided in a first region having a low dielectric constant, and a diplexer is provided in a second region having a high dielectric constant. As an advantageous effect, the antenna substrate component can be miniaturized.

### Additional Example Embodiment 1

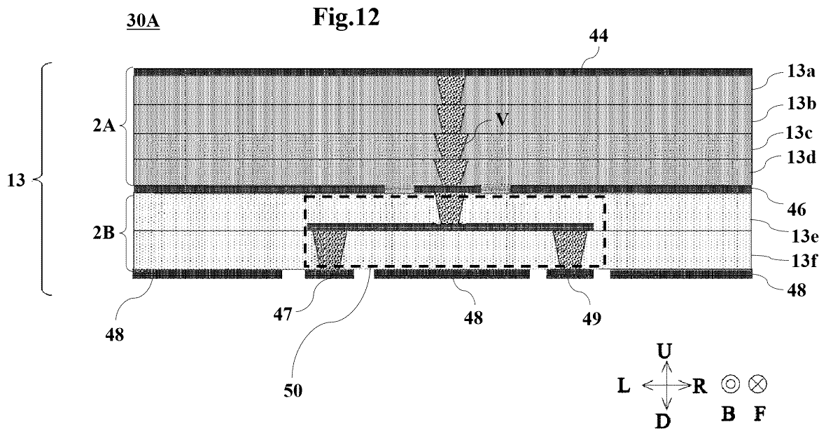

FIG. 12 is an example embodiment of the present invention utilizing features of the present invention in which multiple dielectrics are provided with different dielectric constants, wherein an antenna section has a low dielectric constant, and a diplexer section has a high dielectric constant.

FIG. 12 shows a cross-sectional view of an antenna substrate with a built-in diplexer 30A according to the present example embodiment. As shown in FIG. 12, the antenna substrate with built-in diplexer 30A includes a multilayer substrate 13 which includes a first region 2A and a second region 2B. The first region 2A corresponds to an antenna section, and the second region 2B corresponds to a diplexer section. The first region 2A (antenna section) includes insulator layers 13a, 13b, 13c, and 13d. The second region 2B (diplexer section) includes insulator layers 13e and 13f. The dielectric constant of the insulator layers 13e and 14f is higher than that of the insulator layers 13a to 13d. Thus, a composite dielectric constant of the second region 2B is higher than a composite dielectric constant of the first region 2A. The number of insulating layers in each region (section) is not limited. An antenna radiation electrode 44 is provided in the first region 2A (antenna section). A first ground electrode 46 is located at a boundary between the first region 2A and the second region 2B. A second ground electrode 48 is provided in the second region 2B at the lower side of the multilayer substrate 13 as shown in FIG. 12. A diplexer circuit 50 is provided in the second region 2B and on an inner layer 13f of the second region 2B. The diplexer circuit 50 is sandwiched between the first ground electrode 46 and the second ground electrode 48 in the stacking direction (up-down direction shown in FIG. 12) of the multilayer substrate 13.

As shown in FIG. 12, the diplexer circuit 50 is provided with a first terminal 47 (feed point 1) and a second terminal 49 (power supply point 2). The inner layer 13f of the second region 2B is covered by the second ground electrode 48. The antenna radiation electrode 44 and the diplexer circuit 50 are connected to each other by an interlayer connection conductor V extending through the first region 2A. In FIG. 12 of the present example embodiment, the radiating components located on the negative side of the Z-axis relative to the radiating conductor layer are not explicitly shown, but may be present in the same or substantially the same manner as in the example embodiments described above.

In the antenna substrate 30A shown in FIG. 12, a composite dielectric constant of the second region 2B (diplexer section) is higher than a composite dielectric constant of the first region 2A (antenna section). That is, the antenna section uses a low-k dielectric, and the diplexer section uses a high-k dielectric. As an advantageous effect, broadband radiation characteristics and a reduced size can be obtained. As a result, a small, multi-band driven antenna can be provided. Further, when two power supplies are originally fed to the antenna, the design must take isolation into consideration, resulting in poor characteristics, but with a built-in diplexer, this restriction is eliminated and a highly efficient (broadband) antenna can be provided.

### Additional Example Embodiment 2

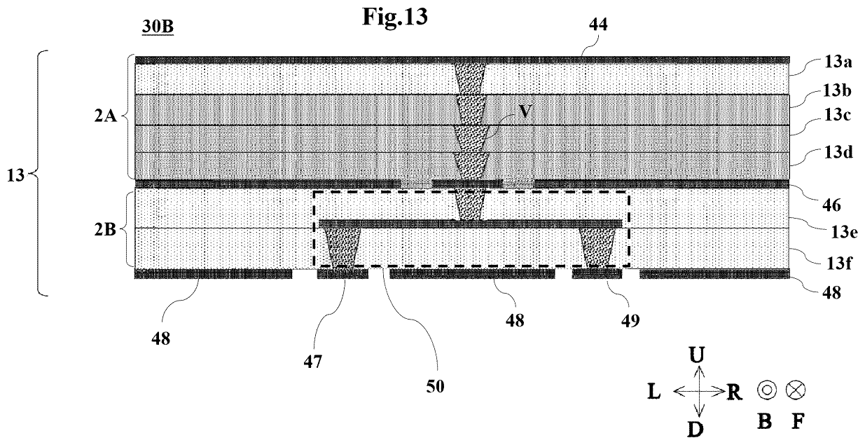

FIG. 13 shows a cross-sectional view of an antenna substrate with a built-in diplexer 30B which is a modified example embodiment of the present invention similar to that of FIG. 12, but where a portion of the antenna section (region 2A) includes a high dielectric material.

In the antenna substrate with built-in diplexer 30B shown in FIG. 13, the first region 2A (antenna section) has a lower composite dielectric constant than that of the second region 2B (diplexer section), as in the example embodiment shown in FIG. 12. However, the first region 2A may include layers with high and low dielectric constants. Specifically, a composite dielectric constant of the second region 2B is higher than a composite dielectric constant of the first region 2A. However, the first region 2A can include a high dielectric layer section including insulator layer 13a and a low dielectric layer section including insulator layers 13b, 13c, and 13d. The low dielectric layer section (e.g., 13b, 13c, and 13d) has a dielectric constant lower than a dielectric constant of the high dielectric layer section (e.g., 13a). As an advantageous effect, the antenna section can be made smaller and with a wider bandwidth. The number of insulating layers in each region or section is not limited.

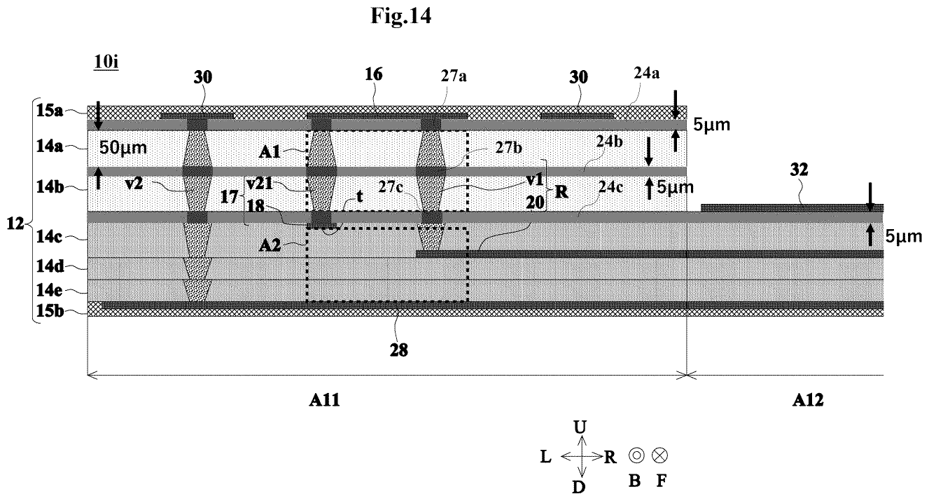

FIG. 14 is a sectional view of an antenna component 10i according to another modification of an example embodiment of the present invention. As shown in FIG. 14, an adhesive layer 24a is provided on the upper side of the high dielectric layer 14a, an adhesive layer 24b is provided between the high dielectric layer 14a and the high dielectric layer 14b, and an adhesive layer 24c is provided on the bottom side of the high dielectric layer 14b. Further, as shown in FIG. 14, a connection conductor layers 27a, 27b, and 27c are provided at each of the adhesive layers 24a, 24b, and 24c, respectively. Advantageously, adhesion is improved between the high dielectric layer and the copper foil, or between the high dielectric layer and other dielectric films.

Preferably, each of the adhesive layers 24a, 24b, 24c has a thickness of, for example, about 5 μm, and the each of the high dielectric layer 14a and the high dielectric layer 14b has a thickness of, for example, about 50 μm. Accordingly, a 5 μm adhesive layer is added on both sides of each of the high dielectric layers. Preferably, each of the high dielectric layers 14a, 14b can be made of, for example, polyimide, epoxy, or polyolefin, etc. with fillers such as strontium titanate, calcium titanate, titanium oxide, etc. to achieve a high dielectric constant. Preferably, the adhesive layers 24a, 24b, 24c can be made of, for example, polyolefin, polypropylene, or polyphenylene ether, etc. The connection conductor layers 27a, 27b, and 27c can be, for example, conductive bonding layers or copper foils.

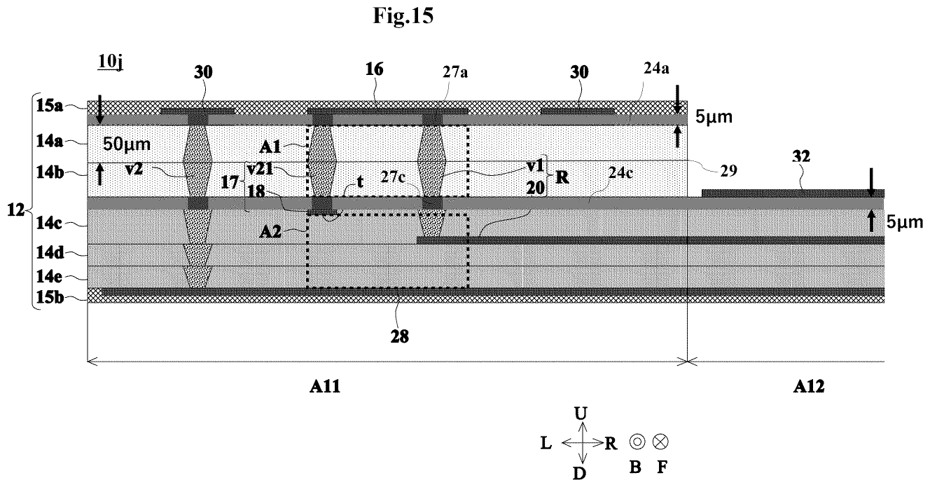

FIG. 15 is a sectional view of an antenna component 10j according to another modification of an example embodiment of the present invention. As shown in FIG. 15, an adhesive layer 24a is provided on the upper side of the high dielectric layer 14a, and an adhesive layer 24c is provided on the bottom side of the high dielectric layer 14b. However, in the present example embodiment, there is no adhesive layer or copper foil provided at a layer interface 29 between the high dielectric layer 14a and the high dielectric layer 14b. Advantageously, the present example embodiment also improves adhesion between the high dielectric layer and the copper foil, or between the high dielectric layer and other dielectric films. While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna component comprising:
a main body;
a first radiating conductor layer;
a radiator; and
a first ground conductor layer; wherein
the main body includes a plurality of insulator layers provided along a Z-axis;
the first radiating conductor layer is provided in the main body;
the radiator is provided in the main body and located on a negative side of the Z-axis relative to the first radiating conductor layer, and the radiator is connected to the first radiating conductor layer and is not connected to a ground potential;
the first ground conductor layer is provided in the main body and overlaps with the first radiating conductor layer and the radiator as viewed in a negative direction of the Z-axis, and the first ground conductor layer is located on the negative side of the Z-axis relative to the first radiating conductor layer;
an end of the radiator on the negative side of the Z-axis is defined as a negative-side end;
a region overlapping with the first radiating conductor layer as viewed in the negative direction of the Z-axis and located on a positive side of the Z-axis relative to the negative-side end and on the negative side of the Z-axis relative to the first radiating conductor layer is defined as a first region, and a region overlapping with the first radiating conductor layer as viewed in the negative direction of the Z-axis and located on the positive side of the Z-axis relative to the first radiating conductor layer and on the negative side of the Z-axis relative to the negative-side end is defined as a second region; and
a composite dielectric constant of the first region is higher than a composite dielectric constant of the second region.

2. The antenna component according to claim 1, wherein
the radiator includes an interlayer connection conductor and a second radiating conductor layer;
the second radiating conductor layer is provided in the main body and located on the negative side of the Z-axis relative to the first radiating conductor layer;
the interlayer connection conductor is provided in the main body, and penetrates one or more of the plurality of insulator layers along the Z-axis and connects the first radiating conductor layer to the second radiating conductor layer; and
an area of the second radiating conductor layer is smaller than an area of the first radiating conductor layer as viewed in the negative direction of the Z-axis.

3. The antenna component according to claim 2, wherein at least a portion of the second radiating conductor layer overlaps with the first radiating conductor layer as viewed in the negative direction of the Z-axis.

4. The antenna component according to claim 3, wherein an area of an overlapping region overlapping with the first radiating conductor layer in the second radiating conductor layer is larger than an area of a non-overlapping region not overlapping with the first radiating conductor layer in the second radiating conductor layer as viewed in the negative direction of the Z-axis.

5. The antenna component according to claim 2, wherein
a direction in which an electric field resonates in the first radiating conductor layer is defined as a resonance direction;
a direction orthogonal or substantially orthogonal to the resonance direction as viewed in the negative direction of the Z-axis is defined as an orthogonal direction; and
a length of the second radiating conductor layer in the orthogonal direction is equal or substantially equal to a length of the first radiating conductor layer in the orthogonal direction.

6. The antenna component according to claim 2, wherein
a direction in which an electric field resonates in the first radiating conductor layer is defined as a resonance direction;
a direction orthogonal or substantially orthogonal to the resonance direction as viewed in the negative direction of the Z-axis is defined as an orthogonal direction; and
a length of the first radiating conductor layer in the orthogonal direction is greater than a length of the first radiating conductor layer in the resonance direction.

7. The antenna component according to claim 1, further comprising:
a second ground conductor layer; wherein
the second ground conductor layer is provided in the main body and has a ring shape surrounding the first radiating conductor layer as viewed in the negative direction of the Z-axis.

8. The antenna component according to claim 1, further comprising:
a current path; wherein
the current path is connected to the first radiating conductor layer; and
a high frequency signal is transmitted in the current path.

9. The antenna component according to claim 8, further comprising:
a branch conductor; wherein
the branch conductor branches from the current path.

10. The antenna component according to claim 9, wherein the branch conductor is located within a range of about ½ or less of a wavelength of the high frequency signal from the first radiating conductor layer.

11. The antenna component according to claim 9, wherein the branch conductor is located in the second region.

12. The antenna component according to claim 1, wherein
the plurality of insulator layers include a first insulator layer and a second insulator layer;
the first insulator layer is located in the first region and the second insulator layer is located in the second region; and
a dielectric constant of the first insulator layers is higher than a dielectric constant of the second insulator layer.

13. The antenna component according to claim 1, wherein the main body is flexible.

14. The antenna component according to claim 12, wherein the first insulator layer includes polyimide, and the second insulator layer includes a liquid crystal polymer.

15. The antenna component according to claim 2, wherein the second radiating conductor layer does not protrude from the first radiating conductor layer as viewed in the negative direction of the Z-axis.

16. The antenna component according to claim 7, wherein the second ground conductor layer has a ring shape surrounding the first radiating conductor layer as viewed in the negative direction of the Z-axis.

17. The antenna component according to claim 12, further comprising:
a mounting electrode on a lower major surface of the first insulator layer.

18. The antenna component according to claim 9, wherein the branch conductor overlaps with the first radiating conductor layer as viewed in the negative direction of the Z-axis.

19. An antenna substrate with built-in diplexer, comprising:
a multilayer substrate including a first region and a second region;
an antenna radiation electrode in the first region;
a first ground electrode at a boundary between the first region and the second region;
a second ground electrode in the second region; and
a diplexer circuit in the second region and on an inner layer of the second region, the diplexer circuit being sandwiched between the first ground electrode and the second ground electrode in a stacking direction of the multilayer substrate; wherein
the inner layer of the second region of the antenna substrate is covered by the second ground electrode;
the antenna radiation electrode and the diplexer circuit are connected to each other by an interlayer connection conductor extending through the first region; and
a composite dielectric constant of the second region is higher than a composite dielectric constant of the first region.

20. The antenna substrate with built-in diplexer according to claim 19, wherein the first region includes a high dielectric layer section and a low dielectric layer section, the low dielectric layer section having a dielectric constant lower than a dielectric constant of the high dielectric layer section.
